(19) United States
(12) Patent Application Publication
(10) Pub. No.: US 2017/0317380 A1
(43) Pub. Date: Nov. 2, 2017

(54) NONAQUEOUS ELECTROLYTE SECONDARY BATTERY

(71) Applicant: Sanyo Electric Co., Ltd., Daito-shi, Osaka (JP)

(72) Inventors: Manabu Takijiri, Osaka (JP); Takanobu Chiga, Osaka (JP); Masaki Hasegawa, Osaka (JP)

(73) Assignee: Sanyo Electric Co., Ltd., Daito-shi, Osaka (JP)

(21) Appl. No.: 15/531,794

(22) PCT Filed: Dec. 17, 2015
(86) PCT No.: PCT/JP2015/006293

§ 371 Date: May 31, 2017

(30) Foreign Application Priority Data
Dec. 26, 2014 (JP) 2014-264893

(51) Int. Cl. H01M 10/0525; H01M 4/38; H01M 4/48; H01M 4/525

(52) U.S. Cl. CPC H01M 10/0525; H01M 4/525; H01M 4/386; H01M 4/483; H01M 2300/0025

(57) ABSTRACT

A non-aqueous electrolyte secondary battery having high input/output characteristics and preferable cycle characteristics is provided. A non-aqueous electrolyte according to one example of an embodiment includes a positive electrode which includes a positive electrode active material containing as a primary component, a lithium transition metal oxide having a layered structure, the content of Co of which is with respect to the total mass of metal elements except Li is 1 to 20 percent by mole; a negative electrode which includes a negative electrode active material containing Si; and a non-aqueous electrolyte which includes a fluorinated chain carboxylic acid ester.

### TECHNICAL FIELD

The present disclosure relates to a non-aqueous electrolyte secondary battery.

### BACKGROUND ART

In Patent Literature 1, a non-aqueous electrolyte secondary battery has been disclosed which includes at least one type of fluorinated solvent selected from a fluorinated chain ether, a fluorinated cyclic ester, and a fluorinated chain carbonate. Patent Literature 1 has disclosed that since a strong coating film is formed on a negative electrode surface by the use of the non-aqueous electrolyte mentioned above, charge/discharge efficiency and long-term charge/discharge cycle resistance of the battery are improved.

### CITATION LIST

### Patent Literature

Patent Literature 1: Japanese Patent No. 5359163

### SUMMARY OF INVENTION

### Technical Problem

Incidentally, for example, mainly in applications of power storage systems for industrial and power supply purposes, it is important for a non-aqueous electrolyte secondary battery to have high input/output characteristics and preferable cycle characteristics (high durability). However, in related techniques including that disclosed in Patent Literature 1, high input/output characteristics and preferable cycle characteristics are difficult to simultaneously obtain, and further improvement of those characteristics has been desired.

### Solution to Problem

A non-aqueous electrolyte secondary battery according to one aspect of the present disclosure comprises: a positive electrode including a positive electrode active material which contains as a primary component, a lithium transition metal oxide having a layered structure, the content of cobalt (Co) of which is with respect to the total mass of metal elements except lithium (Li), 1 to less than 20 percent by mole; a negative electrode including a negative electrode active material which contains silicon (Si); and a non-aqueous electrolyte including a fluorinated chain carboxylic acid ester.

### Advantageous Effects of Invention

According to one aspect of the present disclosure, at non-aqueous electrolyte secondary battery having high input/output characteristics and preferable cycle characteristics (high durability) can be provided.

### BRIEF DESCRIPTION OF DRAWINGS

FIG. 1 is a cross-sectional view of a non-aqueous electrolyte secondary battery according to one example of an embodiment.

### DESCRIPTION OF EMBODIMENTS

In a non-aqueous electrolyte secondary battery according to one aspect of the present disclosure, it is believed that since Co eluted from a positive electrode when the battery is charged reacts specifically with a fluorinated chain carboxylic acid ester on a surface of a negative electrode active material containing Si, a good-quality coating film excellent in ion permeability is formed. Accordingly, high input/output characteristics and a high durability can be simultaneously obtained. The advantageous effects described above are specifically obtained only when a lithium transition metal oxide containing Co at a concentration of 1 to less than 20 percent by mole with respect to the total mass of metal elements except Li, a negative electrode active material including Si, and a fluorinated chain carboxylic acid ester are provided. The non-aqueous electrolyte; secondary battery according to one aspect of the present disclosure is preferably used, for example, in applications of power storage systems for industrial and power supply purposes in which charge/discharge cycle is repeatedly performed several thousands of times.

Hereinafter, one example of the embodiment will be described in detail.

The figure illustrating the embodiment is schematically drawn, and for example, the dimensional ratio of a constituent element thus drawn may be different from that of an actual element in some cases. A concrete dimensional ratio or the like is to be appropriately understood in consideration of the following description.

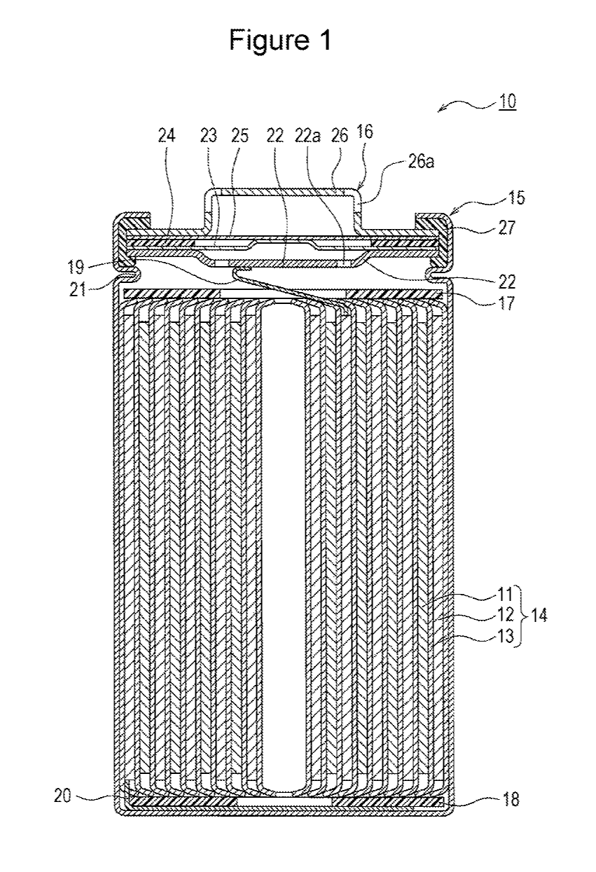

FIG. 1 is a cross-sectional view of a non-aqueous electrolyte secondary battery 10 according to one example of the embodiment.

The non-aqueous electrolyte secondary battery 10 includes a positive electrode 11, a negative electrode 12, and a non-aqueous electrolyte. Between the positive electrode 11 and the negative electrode 12, at least one separator 13 is preferably provided. The non-aqueous electrolyte secondary battery 10 has the structure in which a winding type electrode body 14 formed, for example, by winding the positive electrode 11 and the negative, electrode 12 with the separator 13 interposed therebetween and the non-aqueous electrolyte are received in a battery case. In addition, instead of the winding type electrode body 14, another electrode body, such as a lamination type electrode body in which positive electrodes and negative electrodes are alternately laminated to each other with separators interposed therebetween, may also be used. As the battery case receiving the electrode body 14 and the non-aqueous electrolyte, for example, there may be mentioned a metal-made case having, for example, a cylinder, a rectangular, a coin, or a button shape; or a resin-made case (lamination type battery) formed by laminating resin sheets. In the example shown in FIG. 1, the battery case is composed of a cylindrical case main body 15 having a bottom portion and a sealing body 16.

The non-aqueous electrolyte secondary battery 10 includes insulating plates 17 and 18 provided at the top and the bottom of the electrode body 14, respectively. In the example shown in FIG. 1, a positive electrode lead 19 fitted to the positive electrode 11 extends to a sealing body 16 side through a through-hole of the insulating plate 17, and a negative electrode lead 20 fitted, to the negative electrode 12 extends to a bottom portion side, of the case main body 15 along the outside of the insulating plate 18. For example, the positive electrode lead 19 is connected by welding or the like to a bottom surface of a filter 22 which is a bottom plate of the sealing body 16, and a cap 26 which is a top plate of the sealing body 16 and which is electrically connected to the filter 22 functions as a positive electrode terminal. The negative electrode lead 20 is connected by welding or the like to an inside surface of the bottom portion of the case main body 15, so that the case main body 15 functions as a negative electrode terminal. In this embodiment, the sealing body 16 is provided with a current interrupt device (CID) and a gas exhaust mechanism (safety valve). In addition, the bottom portion of the case main body 15 is preferably provided with a gas exhaust valve (not shown).

The case main body 15 is, for example, a cylindrical metal-made container having a bottom portion. Between the case main body 15 and the sealing body 16, a gasket 27 is provided, so that the air tightness inside the battery case is secured. The case main body 15 preferably has a protrusion portion 21 formed, for example, by pressing a side surface portion from the outside to support the sealing body 16. The protrusion portion 21 is preferably formed to have a ring shape along the circumference direction of the case main body 15, and the sealing body 16 is supported by the upper surface of the protrusion portion 21.

The sealing body 16 includes the filter 22 in which a filter opening portion 22a is formed and a valve body disposed on the filter 22. The valve body blocks the filter opening portion 22a of the filter 22 and is to be fractured when the inside pressure of the battery is increased by heat generation caused by internal short circuit or the like. In this embodiment, as the valve body, a lower valve body 23 and an upper valve body 25 are provided, and an insulating member 24 disposed therebetween and the cap 26 having a cap opening portion 26a are further provided. The individual members forming the sealing body 16 each have, for example, a circular plate shape or a ring shape, and the members other than the insulating member 24 are electrically connected to each other. In particular, the filter 22 and the lower valve body 23 are bonded to each other along the circumference portions thereof, and the upper valve body 25 and the cap 26 are also bonded to each other along the circumference portions thereof. The lower valve body 23 and the upper valve body 25 are connected to each other at the central portions thereof, and between the circumference portions described above, the insulating member 24 is provided. In addition, when the inside pressure is increased by heat generation, caused, by internal short circuit or the like, for example, the lover valve portion 23 is fractured at a thin wall portion thereof. Accordingly, since being swollen to a cap 26 side, the upper valve body 25 is separated from the lower valve body 23, and as a result, the electrical connection therebetween is interrupted.

The non-aqueous electrolyte secondary battery 10 has, for example, a volume energy density of 600 Wh/L or more. As described later, in the non-aqueous electrolyte secondary battery 10, a lithium transition metal oxide is used for the positive electrode active material, and a material capable of occluding and releasing lithium ions is used for the negative electrode active material. In more particular, a lithium transition metal oxide containing cobalt (Co) and a material containing silicon (Si) are used for the positive electrode active material and the negative electrode active material, respectively. Furthermore, as the non-aqueous electrolyte, a non-aqueous solvent containing a fluorinated chain carboxylic acid ester is used.

[Positive Electrode]

The positive, electrode is composed, for example, of a positive electrode collector formed, of metal foil or the like and at least one positive electrode mixed material layer formed on the positive electrode collector. For the positive electrode collector, for example, foil of a metal, such as aluminum, stable in a potential range of the positive electrode or a film disposed on a surface layer of the metal mentioned above may be used. The positive electrode mixed material layer preferably contains, besides the positive electrode active material, an electrically conductive material and a binding material. The positive electrode may be formed in such a way that, for example, after a positive electrode mixed material slurry containing the positive electrode active material the binding material, and the like is applied on the positive electrode collector, and coating films thus obtained are then dried, rolling is performed, so that the positive electrode mixed material layers are formed on two surfaces of the collector.

The positive electrode active material contains as a primary component, a lithium transition metal oxide (hereinafter, referred to as the “lithium transition metal oxide A) having a layered structure, the content of Co of which is with respect to the total mass of the metal elements except Li, 1 to less than 20 percent by mole. The crystalline structure of the lithium transition, metal oxide A is for example, a hexagonal, crystal structure and has a symmetric structure belonging to space group R-3m. Although the positive electrode active material may contain a material other than the lithium transition metal oxide A, the content of the lithium transition metal oxide A is with respect to the total weight of the positive electrode active material, at least 50 percent by weight, preferably 80 percent by weight or more, and more preferably 90 percent by weight or more. In this embodiment, the case in which as the positive electrode active material, the lithium transition metal oxide A is only used will be described. Since the lithium transition metal oxide A containing Co is used, it is believed that a good-quality coating film is formed on the surface of the negative electrode active material containing Si, so that high input/output characteristics and a high durability can be simultaneously obtained.

The content of Co of the lithium transition metal oxide A is as described above, 1 to less than 20 percent by mole, preferably 2 to 15 percent by mole, and more preferably 3 to 12 percent by mole. In a discharged state or a non-reacted state, the lithium transition metal oxide A may be represented, for example, by a general formula of LiₐCoₓM₁₋ₓO₂ (0.9≦a≦1.2, 0.01≦x<0.2, and M represents at least one type of metal, element selected from Ni, Mn, and Al). As the metal element M, for example, there may be mentioned, a transition metal element other than Co, nickel (Ni), and manganese (Mn), an alkali metal element, an alkaline earth metal element, an element of Group 12, an element of Group 13 other than aluminum (Al), and an element of Group 14. In particular, for example, there may be mentioned boron (B), magnesium (Mg), titanium (Ti), chromium (Cr), iron (Fe), copper (Cu), zinc (Zn), zirconium (Zr), strontium (Sr), niobium (Nb), molybdenum (Mo), tin (Sn), tantalum (Ta), tungsten (W), sodium (Na), potassium (K), barium (Ba), and calcium (Ca).

The content of Ni of the lithium transition metal oxide A is with respect to the total mass of the metal elements except Li, preferably 80 percent by mole or more, and more preferably 85 percent by mole or more. When the content of Ni is 80 percent by mole or more, the input/output characteristics and the durability are further improved. In a discharged state or a non-reacted state, the lithium transition metal oxide A is represented, for example, by a general formula of LiₐCOₓNi_{y}M_{1-x-y}O₂ (0.9≦a≦1.2, 0.01≦x<0.2, 0.8≦y<1.0, 0<x+y<1, and M represents at least one type of metal element selected from Mn and Al). One example of a preferable lithium transition metal oxide A is a Ni—Co—Al-based or a Ni—Co—Mn-based composite oxide.

Although being not particularly limited, the grain diameter (volume average grain diameter measured by a laser-diffraction method) of the lithium transition metal oxide A is preferably 2 to 30 μm. The grains of the lithium transition metal oxide A are secondary grains formed, for example, by bonding primary grains having a grain diameter of 50 nm to 10 μm. On the grain surface of the lithium transition metal oxide A, for example, inorganic compound grains formed of tungsten oxide, lithium phosphate, or the like, may be fixed.

The electrically conductive material described above is used to increase the electric conductivity of the positive electrode mixed material layer. As an example of the electrically conductive material, for example, a carbon material, such as carbon black (CB), acetylene black (AB), ketchen black, or graphite, may be mentioned. Those materials may foe used alone, or at least two types thereof may be used in combination.

The binding material described above is used to maintain a preferable contact state between the positive electrode active material and the electrically conductive material and to enhance; a binding property of the positive electrode active material or the like to the surface of the positive electrode collector. As an example of the binding material, for example, there may foe mentioned a fluorine-based resin, such as a polytetrafluoroethylene (PTFE) or a poly(vinylidene fluoride) (PVdF), a polyacrylonitrile (PAN), a polyimide-based resin, an acryl-based resin, or a polyolefin-based resin. In addition, those resins each may be used in combination with a carboxymethyl cellulose (CMC) or its salt (such as CMC-Na, CMC-K, CMC-NH₄, or a partially neutralized salt), a poly(ethylene oxide) (PEO), or the like. Those may be used alone, or at least two types thereof may be used in combination.

[Negative Electrode]

The negative electrode is composed, for example, of a negative electrode collector formed of metal foil or the like and at least one negative electrode mixed material layer formed on the negative electrode collector. For the negative electrode collector, for example, foil of a metal, such as copper, stable in a potential range of the negative electrode or a film disposed on a surface layer of the metal mentioned above may be used. The negative electrode mixed material layer preferably contains besides the negative electrode active material, a binding material. The negative electrode may be formed in such a way that, for example, after a negative electrode mixed-material slurry containing the negative electrode active material, the binding material, and the like is applied on the negative electrode collector, and coating films thus formed are then dried, rolling is performed so as to form the negative electrode mixed material layers on two surfaces of the collector.

For the negative electrode active material, as described above, a material containing Si is used. Since Si may occlude a large amount of lithium ions as compared to that of a carbon material, such as graphite, when this type of material is used for the negative electrode active material, the capacity of the battery can be increased. In addition, when Si is contained in the negative electrode active material, high input/output characteristics and a high durability can be simultaneously obtained. As the material containing Si, although Si may be used, a silicon oxide (hereinafter, referred to as the “silicon oxide B”) is preferably used.

As the silicon oxide B, an oxide represented by SiOₓ (0.8≦x≦1.5) is preferable. The SiOs has the structure in which for example, fine Si grains are dispersed in a matrix of amorphous SiO₂. When SiOₓ grains are observed by a transmission electron microscope (TEM), the presence of Si can be confirmed. Si grains having a size of 200 nm or less, are preferably uniformly dispersed in a matrix of SiO₂. In addition, the SiOₓ grains each also may contain a lithium silicate (such as Li₂SiO₃ or Li₂Si₂O₅). The grain diameter (volume average grain diameter measured by a laser diffraction method) of the silicon oxide B is for example, 1to 15 μm and preferably 4 to 10 μm.

The silicon oxide B preferably has on each grain surface, an electrically conductive layer which is formed from a material having a high electric conductivity as compared to that of SiOₓ. As an electrically conductive material forming the electrically conductive layer, an electrochemically stable material is preferable, and at least one type of material selected from the group consisting of a carbon material, a metal, and a metal compound is preferable. For the carbon material forming the electrically conductive layer, as is the electrically conductive material of the positive electrode mixed material layer, for example, there may be used carbon black, acetylene black, ketchen black, graphite, or a mixture containing at least two types of materials mentioned above.

In order, to secure the electric conductivity and in consideration of the diffusivity of lithium ions to the silicon oxide B, the thickness of the electrically conductive layer is preferably 1 to 200 nm and more preferably 5 to 100 nm. The thickness of the electrically conductive layer can be measured by a cross-section observation of grains using a scanning electron microscope (SEM) or the like. The electrically conductive layer may be formed using a generally known method, such as a CVD method, a sputtering method, or a plating method (electrolytic or non-electrolytic plating). When an electrically conductive layer composed of a carbon material is formed on the grain surfaces of the silicon oxide B by a CVD method, for example, the grains of the silicon oxide B and a hydrocarbon-based gas are heated in a vapor phase, and carbon generated by pyrolysis of the hydrocarbon-based gas is deposited on the grains.

As the negative electrode active material, in consideration of the cycle characteristics, the silicon oxide B is preferably used together with graphite. That is, the negative electrode active material is formed of a mixture of the silicon oxide B and graphite. Although the negative electrode active material may further contain a carbon material or the like other than graphite, the negative electrode active material is preferably formed substantially only from the silicon oxide B and graphite. In view of the improvement in battery capacity, input/output characteristics, and cycle characteristics, the content of the silicon oxide B is for example, preferably 1 to 20 percent by weight with respect to the total weight of the negative electrode active material. The content is more preferably 2 to 15 percent by weight and particularly preferably 3 to 10 percent by weight. The content of the graphite is for example, with respect to the total weight of the negative electrode active material, 80 to 99 percent by weight. That is, the ratio (mixing ratio) of the silicon oxide B to the graphite is preferably 99:1 to 80:20, more preferably 98:2 to 85:15, and particularly preferably 97:3 to 90:10.

As the graphite to be used together with the silicon oxide B, there may be used graphite which has been used as a negative electrode active material of a non-aqueous electrolyte secondary battery. For example, there may be used natural graphite, such as flake graphite, massive graphite, or earthy graphite; or artificial graphite, such as massive artificial graphite (MAG) or graphitized mesophase carbon microbeads (MCMB). The grain diameter (volume average grain diameter measured by a laser diffraction method) of the graphite is for example, 5 to 30 μm and preferably 10 to 25 μm.

As the binding material described above, as is the case of the positive electrode, for example, a fluorine-based resin, a PAN, a polyimide-based resin, an acryl-based resin, or a polyolefin-based resin may be used. When the negative electrode mixed material slurry is prepared using an aqueous solvent, for example, a styrene-butadiene rubber (SBR), a CMC or its salt, a polyacrylic acid (PAA) or its salt (such as PAA-Na, PAA-K, or a partially neutralized salt), or a poly(vinyl alcohol) (PVA) is preferably used.

[Separator]

For the separator, a porous sheet having an ion permeability and an insulating property is used. As a particular example of the porous sheet, a fine porous thin film, a woven cloth, a non-woven cloth, or the like may be mentioned. As a material of the separator, for example, an olefin-based resin, such as a polyethylene or a polypropylene, or a cellulose is preferable. The separator may be a laminate having a cellulose fiber layer and a thermoplastic resin fiber layer formed from an olefin-based resin or the like. In addition, the separator may be a multilayer separator including a polyethylene layer and a polypropylene layer, or a separator having a surface on which a resin, such as an aramid-based resin, is applied may also be used.

On at least one of the interfaces of the separator with the positive electrode and the negative electrode, a filler layer containing an inorganic filler may be formed. As the inorganic filler, for example, an oxide containing at least one of Ti, Al, Si, and Mg, or a phosphoric, acid compound may be mentioned. The filler layer may be formed, for example, by applying a slurry containing the filler described above on the surface of the positive electrode, the negative electrode, or the separator.

[Non-Aqueous Electrolyte]

The non-aqueous electrolyte contains a non-aqueous solvent and an electrolyte salt dissolved in the non-aqueous solvent. The non-aqueous solvent contains at least a fluorinated chain carboxylic acid ester as described above. For the non-aqueous solvent, for example, there may be used an ester other than the fluorinated chain carboxylic acid ester, an ether, a nitrile, an amide, such as dimethylformamide, or a mixed solvent containing at least two types of those mentioned above. In addition, a sulfone group-containing compound, such as propane sultone, may also be used. The non-aqueous-solvent may include a halogen-substituted material in which at least one hydrogen atom of each of the solvents mentioned above is substituted by a halogen atom, such as fluorine.

For the fluorinated chain carboxylic acid ester described above, a fluorinated chain carboxylic acid ester having 3 to 5 carbon atoms is preferably used. As a particular example, for example, there may be mentioned a fluorinated propionic acid methyl ester, a fluorinated propionic acid ethyl ester, a fluorinated acetic acid methyl ester, a fluorinated acetic acid ethyl ester, or a fluorinated acetic acid propyl ester. Among those mentioned above, a fluorinated propionic acid methyl ester (FMP), in particular, 3,3,3-trifluoropropionic acid methyl ester, is preferably used. The content of the fluorinated chain carboxylic acid ester is with respect to the total volume of the non-aqueous solvent forming the non-aqueous electrolyte, preferably 40 to 90 percent by volume. When the content of the fluorinated chain carboxylic acid ester is in the range described above, a good-quality coating film having an excellent ion permeability is likely to be formed on the surface of the negative electrode.

As an example of the ester (other than the fluorinated chain carboxylic acid ester) described above, for example, there may be mentioned a cyclic carbonate ester, such as ethylene carbonate (EC), propylene carbonate (PC), butylene carbonate, or vinylene carbonate; a chain carbonate ester, such as dimethyl carbonate (DMC), methyl ethyl carbonate (EMC), diethyl carbonate (DEC), methyl propyl carbonate, ethyl propyl carbonate, or methyl isopropyl carbonate; a cyclic carboxylic acid ester, such as γ-butyrolactone (GBL) or γ-valerolactone (GVL), or a halogen-substituted material in which at least one hydrogen atom of each of the solvents mentioned above is substituted by a halogen atom, such as fluorine. In addition, the non-aqueous solvent may also contain a non-fluorinated chain carboxylic acid ester.

As an example of the ether mentioned above, for example, there may be mentioned a cyclic ether, such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, or a crown ether; a chain ether, such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybensene, 1,2-dietlioxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, or tetraethylene glycol dimethyl; or a halogen-substituted material in which at least one hydrogen atom of each of those solvents mentioned above is substituted by a halogen atom, such as fluorine.

As an example of the nitrile described above, for example, there may be mentioned acetonitrile, propionitrile, butyronitrile, valeronitrile, n-heptanenitrile, succinonitrile, glutaronitrile, adiponitrile, pimelonitrile, 1,2,3-propanetricarbonitrile, 1,3,5-pentanetricarbonitrile, or a halogen-substituted material in which at least one hydrogen atom of each of the solvents mentioned above is substituted by a halogen atom, such as fluorine.

As the non-aqueous solvent, it is particularly preferable that the fluorinated chain carboxylic acid ester and a cyclic carbonate, in particular, a fluorinated cyclic carbonate, are used in combination. The content of the total of the fluorinated chain carboxylic acid ester and the fluorinated cyclic carbonate is with respect to the total volume of the non-aqueous solvent, preferably set to 50 percent by volume or more and more preferably set to 80 percent by volume or more. The content of the fluorinated chain carboxylic acid ester is as described, above, with respect to the total volume of the non-aqueous solvent, preferably 40 to 90 percent by volume and more preferably 50 to 85 percent by volume. The content of the fluorinated cyclic carbonate is for example, with respect to the total volume of the non-aqueous solvent, 3 to 20 percent by volume. As the fluorinated cyclic carbonate to be used together with the fluorinated chain carboxylic acid ester, for example, there may be mentioned 4-fluoroethylene carbonate (FEC), 4,5-difluoro-1,3-dioxolane-2-one, 4,4-difluoro-1,3-dioxolane-2-one, 4-fluoro-5-methyl-1,3-dioxolane-2-one, 4-fluoro-4-methyl-1,3-dioxolane-2-one, 4-trifiuoromethyl-1,3-dioxolane-2-one, or 4,5-difluoro-4,5-dimethyl-1,3-dioxolane-2-one (DFBC). Among those mentioned above, FEC is particularly preferable.

The electrolyte salt is preferably a lithium salt. As an example of the lithium salt, for example, there may be mentioned a boric acid salt, such as LiBF₄, LiClO₄, LiPF₆, LiAsF₆, LiSbF₆, LiAlCl₄, LiSCN, LiCF₃SO₃, LiC(C₂F₅SO₂), LiCF₃CO₂, Li(P(C₂O₄)F₄), Li(P(C₂O₄)F₂) , LiPF₆₋ₓ(CₙF₂ₙ₊₁)ₓ (1<x<6, and n indicates 1 or 2), LiB₁₀Cl₁₀, LiCl, LiBr, LiI, chloroboran lithium, a lower aliphatic carboxylic acid lithium, Li₂B₄O₇, Li(B(C₂O₂) [lithium-bis(oxalate)borate (LiBOB)], or Li(B(C₂O₄); or an inside salt, such as LiN(FSO₂)₂, or LiN(C₁F₂₁₊₁SO₂)(CₘF₂ₘ₊₁SO₂) {1 and m each indicate an integer of 1 or more}. Those lithium salts may be used alone, or at least two types thereof may be used in combination. Among those mentioned above, in view of the ion conductivity, the electrochemical stability, and the like, at least a fluorine-containing lithium salt is preferably used, and for example, LiPF₆ is preferably used. Since a stable coating film is formed on the surface of the negative electrode even in a high-temperature environment, in particular, a fluorine-containing lithium salt and a lithium salt (such as LiBOB) having an oxalato complex as an anion are preferably used in combination. The concentration of the lithium salt is preferably set to 0.8 to 1.8 moles per one liter of the non-aqueous solvent.

### EXAMPLES

Hereinafter, although the present disclosure will be described in more detail with reference to examples, the present disclosure is not limited thereto.

### Example 1

[Formation of Positive Electrode]

After 100 parts by weight of a lithium nickel cobalt aluminum composite oxide represented by LiNi_{0.88}CO_{0.09}Al_{0.03}O₂ and functioning as the positive electrode active material, 1 part by weight of acetylene black (AB), and 1 part by weight of a poly(vinylidene fluoride) (PVdF) were mixed together, an appropriate amount of N-methyl-2-pyrrolidone (NMP) was further added, so that a positive electrode mixed material slurry was prepared. Next, the positive electrode mixed material slurry described above was applied to two surfaces of a positive electrode collector formed of aluminum foil and was then dried. The collector thus processed was cut into a predetermined electrode size and was then rolled using a roller machine, so that a positive electrode in which positive electrode mixed material layers were provided on the two surfaces of the positive electrode collector was formed. In addition, the crystalline structure of LiNi_{0.88}CO_{0.09}Al_{0.93}O₂ is a layered rock-salt structure (hexagonal crystal, space group R3-m).

[Formation of Negative Electrode]

After 4 parts by weight of silicon oxide (SiO) grains having surfaces covered with carbon and functioning as the negative electrode active material, 96 parts by weight of a graphite powder (C), 1 part by weight of a carboxymethyl cellulose (CMC), and 1 part by weight of a styrene-butadiene rubber (SBR) were mixed together, an appropriate amount of water was further added, so that a negative electrode mixed material slurry was prepared. Next, the negative electrode mixed material slurry described above was applied to two surfaces of a negative electrode collector formed from copper foil and was then dried. The collector thus processed was cut into a predetermined electrode size and was then rolled using a roller machine, so that a negative electrode in which negative electrode mixed material layers were formed on the two surfaces of the negative electrode collector was formed.

[Formation of Non-Aqueous Electrolyte]

First, 4-fluoroethylene carbonate (FEC) and 3,3,3-trifluoropropionic acid methyl ester (FMP) were mixed at a volume ratio of 15:85. In this mixed solvent, LiPF₆ was dissolved to have a concentration of 1.2 mol/L, so that a non-aqueous electrolyte was formed. In addition, to 100 parts by weight of the electrolyte, 0.5 parts by weight of vinylene carbonate and 1 part by weight of propene sultone were added.

[Formation of Battery]

After an aluminum lead and a nickel lead were fitted to the above positive electrode and the above negative electrode, respectively, the positive electrode and the negative electrode were wound with separators interposed therebetween, so that a winding type electrode body was formed. As the separator, a polyethylene-made fine porous film was used which had one surface provided with a heat resistant layer containing a polyamide and an alumina filler in a dispersed state. After this electrode body was received in a cylindrical battery case main body having a bottom portion and having an outer diameter of 18.2 mm and a height of 65 mm, and the non-aqueous electrolyte described above was then charged therein, an opening portion of the battery case main body was sealed with a gasket and a sealing body, so that a 18650-type cylindrical non-aqueous electrolyte secondary battery X1 was formed.

### Comparative Example 1

Except that the non-aqueous electrolyte was formed using EMC instead of FMP, a battery Y1 was formed in a manner similar to that of Example 1.

### Comparative Example 2

Except that as the negative electrode active material, graphite was only used without using silicon oxide, a battery Y2 was formed in a manner similar to that of Example 1.

### Comparative Example 3

Except that the non-aqueous electrolyte was formed using EMC instead of FMP, a battery Y3 was formed in a manner similar to that of Comparative Example 2.

### Comparative Example 4

Except that the positive electrode was formed using LiNi_{0.50}CO_{0.20}Mn_{0.30}O₂ instead of LiNi_{0.88}Co_{0.09}Al_{0.03}O₂, a battery Y4 was formed in a manner similar to that of Example 1.

### Comparative Example 5

Except that the non-aqueous electrolyte was formed using EMC instead of FMP, a battery Y5 was formed in a manner similar to that of Comparative Example 4.

### Comparative Example 6

Except that as the negative electrode active material, graphite was only used without using silicon oxide, a battery Y6 was formed in a manner similar to that of Comparative Example 4.

### Comparative Example 7

Except that the non-aqueous electrolyte was formed using EMC instead of FMP, a battery Y7 was formed in a manner similar to that of Comparative Example 6.

[Evaluation of Input/Output Characteristics],

After the following change/discharge cycle was repeatedly performed on each of the batteries described above, the resistance thereof was measured, so that the input/output characteristics were evaluated.

After charge was performed at 0.3 It (1,000 mA) to 100% of a rated capacity (that is, after the state of charge (SOC) reached 100%), in an environment at 25° C., discharge was performed at a current of 0.5 It (1,500 mA) for 20 seconds from an open-circuit voltage. From the voltage after 20 seconds from the start of the discharge and the voltage right before the start of the discharge, the resistance at 25° C. was calculated using the following formula 1. In addition, the resistance of each of the cells Y1 to Y7 was shown by a relative value obtained when the resistance of the cell X1 was assumed as 100%.

$$Resistance = \frac{\begin{matrix}( Voltage right before Start of Discharge ) - \\ ( Voltage after 20 Seconds from Start of Discharge ) \end{matrix}}{Discharge Current} \qquad ( Formula 1 )$$

[Evaluation of Cycle Characteristics (Durability)]

After the following charge/discharge cycle was repeatedly performed on each of the batteries described above, a capacity retention rate was measured, so that the cycle characteristics (durability) were evaluated.

In a temperature environment at 25° C., each battery was charged at a constant current of 0.3 It (1,000 mA to a battery voltage of 4.2 V, and after the battery voltage reached 4.2 V, charge was performed at a constant voltage. Next, discharge was performed at a constant current of 0.3 It (1,000 mA) mA to a battery voltage of 3.0 V, and the discharge capacity (initial capacity) in this case was obtained. This charge/discharge cycle was repeatedly performed, and the value obtained by dividing the discharge capacity after 100 cycles by the initial capacity was multiplied by 100, so that the capacity retention rate was calculated.

TABLE 1

| | | Negative | | | |
|---|---|---|---|---|---|
| | | Electrode | | Resis- | Capacity |
| Bat- | Positive Electrode | Active | | tance | Retention |
| tery | Active Material | Material | FMP | (%) | Rate (%) |
| X1 | LiNi_{0.88}Co_{0.09}Al_{0.03}O₂ | C + SiO | Yes | 100 | 93.7 |
| Y1 | LiNi_{0.88}Co_{0.09}Al_{0.03}O₂ | C + SiO | No | 109 | 91.6 |
| Y2 | LiNi_{0.88}Co_{0.99}Al_{0.03}O₂ | C | Yes | 129 | — |
| Y3 | LiNi_{0.88}Co_{0.09}Al_{0.03}O₂ | C | No | 116 | — |
| Y4 | LiNi_{0.50}Co_{0.20}Mn_{0.30}O₂ | C + SiO | Yes | 110 | — |
| Y5 | LiNi_{0.50}Co_{0.20}Mn_{0.30}O₂ | C + SiO | No | 105 | — |
| Y6 | LiNi_{0.50}Co_{0.20}Mn_{0.30}O₂ | C | Yes | 181 | — |
| Y7 | LiNi_{0.50}Co_{0.20}Mn_{0.30}O₂ | C | No | 167 | — |

As apparent from Table 1, in the battery X1 in which LiNi_{0.88}Co_{0.09}Al_{0.03}O₂ was used as the positive electrode active material, the material containing Si was used as the negative electrode active material, and FMP was contained in the non-aqueous electrolyte, compared to each of the batteries of the comparative examples, the resistance was low, and the capacity retention rate was high. That is, the battery X1 has high input/output characteristics and preferable cycle characteristics as compared to those of each of the batteries of the comparative examples. The reason for this is believed that since Co eluted from the positive electrode when the battery is charged specifically reacts with a fluorinated chain carboxylic acid ester on the surface of the negative electrode active material containing Si, a good-quality coating film containing Co and Si and having an excellent ion permeability is formed. On the other hand, in the case in which the negative electrode active material containing no Si (batteries Y2, Y3, Y6, and Y7) and in the case in which the content of Co is 20 percent by mole or more (batteries Y4 to Y7), the resistance was high, and preferable input/output characteristics could not be obtained. When the negative electrode active material contains no Si, it is believed that since Si is not contained in the coating film formed on the surface of the negative electrode, the coating film formed as that of the battery X1 is not formed, so that the resistance is increased. When the content of Co is excessively increased, it is believed that since the thickness of the coating film formed with FMP cm the surface of the negative, electrode containing Si is excessively increased, the resistance is increased. In addition, when the content of Co is excessively small, (such as less than 1 percent by mole), it is believed that the amount of Co required to form a good-quality coating film is insufficient. In addition, in each of the batteries of the comparative examples, by addition of FMP, the resistance is unexpectedly increased. That is, only in the case in which the structure of the present disclosure described above is used, advantageous effects in which high input/output characteristics and an increase in serviceable life are simultaneously achieved can be obtained.

### REFERENCE SIGNS LIST

10 non-aqueous electrolyte secondary battery, 11 positive electrode, 12 negative electrode, 13 separator, 14 electrode body, 15 case main body, 16 sealing body, 17, 18 insulating plate, 19 positive electrode lead, 20 negative electrode lead, 22 filter, 22 a filter opening portion, 23 lower valve body, 24 insulating member, 25 upper valve body, 26 cap, 26a cap opening portion, 27 gasket

1. A non-aqueous electrolyte secondary battery comprising:
a positive electrode which includes a positive electrode active material containing as a primary component, a lithium transition metal oxide which has a layered structure, the content of cobalt (Co) of which is with respect to the total mass of metal elements except lithium (Li) is 1 to less than 20 percent by mole;
a negative electrode which includes a negative electrode active material containing silicon (Si); and
a non-aqueous electrolyte which includes a fluorinated chain carboxylic acid ester.

2. The non-aqueous electrolyte secondary battery according to claim 1,
wherein in the lithium transition metal oxide, the content of nickel (Ni) with respect to the total mass of the metal elements except Li is 80 percent by mole or more.

3. The non-aqueous electrolyte secondary battery according to claim 1,
wherein the negative electrode active material is formed of a mixture of a silicon oxide represented by SiOₓ (0.8≦x≦1.5) and graphite,
the content of the silicon oxide is with respect to the total weight of the negative electrode active material 1 to 20 percent by weight, and the content of the graphite is 80 to 99 percent by weight.

4. The non-aqueous electrolyte secondary battery according to claim 1,
wherein the fluorinated chain carboxylic acid ester is a fluorinated propionic acid methyl ester.

5. The non-aqueous electrolyte secondary battery according to claim 1,
wherein the content of the fluorinated chain carboxylic acid ester is with respect to the total volume of a nonaqueous solvent forming the non-aqueous electrolyte, 40 to 90 percent by volume.
